(19) United States
(12) Patent Application Publication
(10) Pub. No.: US 2020/0156179 A1
(43) Pub. Date: May 21, 2020

(54) PROCESSING TOOL FOR ELECTRODE FOR RESISTANCE SPOT WELDING, PROCESSING DEVICE FOR ELECTRODE FOR RESISTANCE SPOT WELDING, AND PROCESSING METHOD FOR ELECTRODE FOR RESISTANCE SPOT WELDING

(71) Applicant: TOYOTA JIDOSHA KABUSHIKI KAISHA, Toyota-shi (JP)

(72) Inventors: Toru HIOKI, Miyoshi-shi (JP); Manabu OOGA, Toyota-shi (JP); Shun KATO, Ichinomiya-shi (JP)

(73) Assignee: TOYOTA JIDOSHA KABUSHIKI KAISHA, Toyota-shi (JP)

(21) Appl. No.: 16/659,615

(22) Filed: Oct. 22, 2019

(30) Foreign Application Priority Data
Nov. 16, 2018 (JP) 2018-215357

(51) Int. Cl. B23K 11/30; B23K 35/02; B23B 5/16; B23K 35/40

(52) U.S. Cl. CPC B23K 11/3009; B23K 35/0261; B23K 2103/10; B23K 35/402; B23B 5/166

(57) ABSTRACT

A transfer processing unit of a processing tool for an electrode for resistance spot welding that is configured to mold, through transfer processing, a projection portion and a plurality of recess portions at an electrode tip portion bulging into a projecting shape is provided with a plurality of protrusions that are configured to mold the plurality of the recess portions respectively. A virtual plane that links tips of the plurality of these protrusions with one another assumes a shape coinciding with a surface shape of the electrode tip portion bulging into the projecting shape before transfer processing.

### INCORPORATION BY REFERENCE

The disclosure of Japanese Patent Application No. 2018-215357 filed on Nov. 16, 2018 including the specification, drawings and abstract is incorporated herein by reference in its entirety.

### BACKGROUND

### 1. Technical Field

The disclosure relates to a processing tool for an electrode for resistance spot welding, a processing device for an electrode for resistance spot welding that is equipped with the processing tool for the electrode for resistance spot welding, and a processing method for the electrode for resistance spot welding through the use of the processing tool for the electrode for resistance spot welding. In particular, the disclosure relates to an improvement for processing an electrode tip portion of the electrode for resistance spot welding.

### 2. Description of Related Art

Conventionally, as an electrode for welding that is used for resistance spot welding of metal plate materials (an electrode for resistance spot welding), there is known an electrode having an electrode tip portion where a projection portion and a recess portion are provided to destroy an oxidation film present on a surface of each of the metal plate materials (especially aluminum alloy plate materials) (e.g., see Japanese Patent Application Publication No. 4-339573 (JP 4-339573 A)).

The electrode for welding (which may be referred to hereinafter simply as the electrode) disclosed in this Japanese Patent Application Publication No. 4-339573 (JP 4-339573 A) has an electrode tip portion where a plurality of projection portions assuming the shape of a quadrangular pyramid are provided in a lattice arrangement. By thus providing the plurality of the projection portions at the electrode tip portion, the oxidation film can be destroyed over an extensive range at the time of resistance spot welding (when the metal plate materials are held by a pair of such electrodes), and current can be kept from concentrating on part of each of the metal plate materials (current can be kept from concentrating on a weak region of the oxidation film in a state where the oxidation film is not destroyed). Thus, the temperature can be restrained from rising locally, and the electrode tip portion can be restrained from melting and adhering to each of the metal plate materials.

Besides, in this Japanese Patent Application Publication No. 4-339573 (JP 4-339573 A), there is disclosed a processing tool for an electrode for welding (which may be referred to hereinafter simply as an electrode processing tool) for molding recesses and projections (the projection portions and recess portions among the projection portions) at the electrode tip portion. The electrode processing tool disclosed in this Japanese Patent Application Publication No. 4-339573 (JP 4-339573 A) has an upper surface and a lower surface (transfer processing units) where a plurality of recess portions assuming the shape of a quadrangular pyramid (recess portions for molding the projection portions at the electrode tip portion) are provided in a lattice arrangement. Then, each of these electrode tip portions with a projection portion and a recess portion is mold by pressing the electrode tip portion of each of the electrodes (the pair of the upper and lower electrodes) against each of the transfer processing units of this electrode processing tool (holding the electrode processing tool by the pair of the electrodes with a predetermined pressurizing force), and transferring the shape of each of the transfer processing units onto each of these electrode tip portions.

### SUMMARY

As disclosed in Japanese Patent Application Publication No. 4-339573 (JP 4-339573 A) as well, each of the electrode tip portions assumes the shape of a substantially spherical projection. This is because the metal plate materials should be prevented from being deformed or cracked at the time of, for example, resistance spot welding.

In the case where the shape of each of the transfer processing units of the electrode processing tool is transferred onto each of the electrode tip portions assuming the shape of this substantially spherical projection, when a virtual plane that links tips of the protrusions that are provided at each of the transfer processing units of this electrode processing tool (the protrusions for molding the recess portions at each of the electrode tip portions) is a flat surface, a region of an outer peripheral side of each of the electrode tip portions is still out of contact with the protrusions even if a region of a central portion of each of the electrode tip portions comes into contact with the protrusions, and the depth of the recess portions that are formed in the region of this outer peripheral side tends to be small at the end of transfer processing. That is, the height of the projection portions that are molded at each of the electrode tip portions tends to be low in the region of this outer peripheral side.

The inventors of the disclosure have found out that the height of the projection portions that are molded at each of the electrode tip portions is preferably guaranteed to be substantially equal over an extensive range from the region of the central portion of this electrode tip portion to the region of the outer peripheral side thereof in order to destroy the oxidation film over the extensive range and restrain the adhesion through melting at the time of resistance spot welding. That is, the inventors of the disclosure have considered optimization of the transfer processing units of the electrode processing tool, based on new knowledge that is not taken into account in Japanese Patent Application Publication No. 4-339573 (JP 4-339573 A).

The disclosure provides a processing tool for an electrode for resistance spot welding, a processing device for the electrode for the resistance spot welding, and a processing method for the electrode for the resistance spot welding that can guarantee an equal height of a projection portion that is molded at an electrode tip portion over an extensive range from a region of a central portion of this electrode tip portion to a region of an outer peripheral side thereof, in recessing and projecting the electrode tip portion.

A first aspect of the disclosure relates to a processing tool for an electrode for resistance spot welding that is configured to mold a projection portion and a plurality of recess portions, through transfer processing, at an electrode tip portion of the electrode for resistance spot welding which bulges into a projecting shape. This processing tool for the electrode for the resistance spot welding is equipped with a transfer processing unit that is configured to carry out transfer processing of the projection portion and the plurality of the recess portions at the electrode tip portion. The transfer processing unit is provided with a plurality of protrusions that are configured to mold the plurality of the recess portions at the electrode tip portion. A virtual plane that links tips of the plurality of these protrusions with one another assumes a shape coinciding with a surface shape of the electrode tip portion bulging into the projecting shape before the transfer processing.

Incidentally, “the coincident shape” mentioned herein is a concept encompassing a substantially coincident shape (a similar shape or a practically coincident shape) as well as a completely coincident shape (an identical shape). Besides, “the surface shape of the electrode tip portion bulging into the projecting shape before transfer processing” is a concept encompassing the shape of the surface of the electrode tip portion on which once a projection portion and recess portions are mold and has been used for resistance spot welding (e.g., the surface of the electrode tip portion that has been shaped (adjusted in shape) in such a manner as to bulge into the projecting shape after being used for resistance spot welding) as well as the shape of the electrode tip portion where no recess portion has been molded (the smooth surface bulging into the projecting shape).

In carrying out transfer processing of the electrode tip portion by the processing tool for the electrode for the resistance spot welding, the electrode tip portion is pressed against the transfer processing unit of the processing tool for the electrode for the resistance spot welding. The virtual plane that links the tips of the plurality of the protrusions that are provided at the transfer processing unit with one another assumes the shape coinciding with the surface shape of the electrode tip portion bulging into the projecting shape before transfer processing. Therefore, at the time of this transfer processing, the respective protrusions substantially simultaneously come into contact with respective portions of the electrode tip portion to mold the recess portions at the electrode tip portion. Therefore, the similar recess portions are molded over an extensive range of the electrode tip portion, and as a result, the height of the projection portion that is molded at the electrode tip portion can be guaranteed to be equal over an extensive range from a region of a central portion of this electrode tip portion to a region of an outer peripheral side thereof. Consequently, at the time of the resistance spot welding through the use of this electrode for the resistance spot welding, a film (e.g., an oxidation film) present on a surface of each of metal plate materials can be destroyed over an extensive range, current can be kept from concentrating on part of each of the metal plate materials (current can be kept from concentrating on a weak region of the film in a state where the film is not destroyed), and the electrode tip portion can be restrained from melting and adhering to each of the metal plate materials.

Besides, a bottom surface of the transfer processing unit, which is a region other than regions where the plurality of the protrusions are provided, may also assume the shape coinciding with the surface shape of the electrode tip portion bulging into the projecting shape before the transfer processing.

In carrying out transfer processing of the electrode tip portion by the processing tool for the electrode for the resistance spot welding, the recess portions are molded at the electrode tip portion, so the electrode tip portion may deform as a result (a material thereof may flow toward the outer peripheral side). However, the bottom surface of the transfer processing unit assumes the shape coinciding with the surface shape of the electrode tip portion bulging into the projecting shape before transfer processing. Therefore, this electrode tip portion is restrained from deforming (the material thereof is restrained from flowing toward the outer peripheral side thereof), and the shape of the electrode tip portion after transfer processing (the projecting shape formed into a protrusion shape) is maintained well.

Besides, each of the protrusions may assume a shape of a cone that is tapered toward a tip side thereof.

According to this, when the electrode tip portion is subjected to transfer processing by the processing tool for the electrode for the resistance spot welding, each of the protrusions is likely to bite into the electrode tip portion, and a depth of each of the recess portions that are molded at the electrode tip portion can be sufficiently ensured. That is, the film present on the surface of each of the metal plate materials can be destroyed well at the time of the resistance spot welding, by sufficiently ensuring a height of the projection portion that is molded at the electrode tip portion.

Besides, the transfer processing may be carried out through movement of the electrode for the resistance spot welding in a direction along a centerline of the electrode for the resistance spot welding and pressing of the electrode tip portion against the transfer processing unit. A centerline of each of the protrusions may extend in the direction along the centerline of the electrode for the resistance spot welding when the transfer processing is carried out.

According to this, in carrying out transfer processing of the electrode tip portion by the processing tool for the electrode for the resistance spot welding, each of the protrusions of the processing tool for the electrode for the resistance spot welding bites well into the electrode tip portion, and the depth of each of the recess portions that are molded at the electrode tip portion can be sufficiently ensured. That is, according to this configuration as well, the film present on the surface of each of the metal plate materials can be destroyed well at the time of the resistance spot welding, by sufficiently ensuring the height of the projection portion that is molded at the electrode tip portion.

Besides, the plurality of the protrusions may be disposed in a dispersed manner at positions that are point-symmetric with respect to a central position of the transfer processing unit, at the transfer processing unit.

According to this, at the time of the resistance spot welding by the electrode having the electrode tip portion where the projection portion and the recess portions are molded by the processing tool for the electrode for the resistance spot welding, the current flowing through each of the metal plate materials can be uniformly distributed. Therefore, current can be restrained from concentrating locally, an odd-shaped nugget can be restrained from being formed, and the reliability can be enhanced in obtaining a target nugget diameter.

Besides, a height of each of the protrusions may be equal to or higher than 30 μm and equal to or lower than 150 μm.

This is because the film present on the surface of each of the metal plate materials cannot be sufficiently destroyed due to an insufficiency in the protrusion amount (the height) of the projection portion that is molded at the electrode tip portion, and the adhesion through melting may be caused, when the height of each of the protrusions is lower than 30 μm Besides, this is because the protrusions may be damaged in molding the recess portions at the electrode tip portion, when the height of each of the protrusions is higher than 150 μm.

Besides, a distance between central positions of those of the protrusions which are adjacent to each other may be equal to or longer than 400 μm and equal to or shorter than 1200 μm.

This is because it is difficult to prepare the processing tool for the electrode for the resistance spot welding, and also, the amount of energy needed to obtain the target nugget diameter at the time of the resistance spot welding significantly increases, when the distance between the central positions of those of the protrusions which are adjacent to each other is shorter than 400 μm. Besides, this is because the film cannot be sufficiently destroyed due to too large a contact area between the electrode tip portion and each of the metal plate materials, and the adhesion through melting may be caused, when the distance between the central positions of those of the protrusions which are adjacent to each other is longer than 1200 μm.

Besides, a bottom surface of each of the protrusions may be square, and a length of one side of the bottom surface of each of the protrusions may be equal to or longer than 80 μm and equal to or shorter than 350 μm.

This is because the protrusions may be damaged in molding the recess portions at the electrode tip portion when the length of one side of the bottom surface of each of the protrusions is shorter than 80 μm. Besides, this is because the local concentration of current is promoted due to too small a contact area between each of the metal plate materials and the electrode tip portion at the time of the resistance spot welding, and the adhesion through melting may be caused, when the length of one side of the bottom surface of each of the protrusions is longer than 350 μm.

A second aspect of the disclosure relates to a processing device for an electrode for the resistance spot welding that is equipped with the foregoing processing tool for the electrode for the resistance spot welding.

The processing device for the electrode for the resistance spot welding may be further equipped with a device body. The processing tool for the electrode for welding may be retained by the device body via an elastic body.

According to this, in carrying out transfer processing of the electrode tip portion by the processing tool for the electrode for the resistance spot welding, even when the electrode for the resistance spot welding diagonally comes into contact with the processing tool for the electrode for the resistance spot welding, namely, even when the direction in which the electrode for the resistance spot welding moves is inclined with respect to the direction perpendicular to the direction in which the transfer processing unit extends, the posture of the processing tool for the electrode for the resistance spot welding changes due to elastic deformation of the elastic body at the time of contact of the electrode for the resistance spot welding with the processing tool for the electrode for the resistance spot welding, and the transfer processing unit extends in the direction perpendicular to the direction in which the electrode for the resistance spot welding moves. Thus, the similar recess portions are molded over an extensive range of the electrode tip portion, and the recess portions and the projection portion of the electrode tip portion can be molded well.

Besides, the processing device for the electrode for the resistance spot welding may be equipped with a shaping device that is configured to perform a shaping operation for bulging the electrode tip portion of the electrode for the resistance spot welding into a predetermined projecting shape, at a stage prior to transfer processing of the projection portion and the plurality of the recess portions by the processing tool for the electrode for the resistance spot welding. A shape of a shaping unit of the shaping device on which the electrode tip portion abuts may coincide with a shape of the virtual plane that links the tips of the plurality of the projections of the processing tool for the electrode for the resistance spot welding with one another.

According to this, the electrode tip portion can bulge into the projecting shape through the shaping operation by the shaping device at a stage prior to transfer processing of the electrode tip portion by the processing tool for the electrode for the resistance spot welding (can bulge into a shape coinciding with the shape of the virtual plane that links the tips of the plurality of the protrusions of the processing tool for the electrode for the resistance spot welding with one another), and the recess portions and the projection portion of the electrode tip portion can be molded well at the time of transfer processing.

A third aspect of the disclosure relates to a processing method for an electrode for resistance spot welding through the use of the processing tool for the electrode for the resistance spot welding. That is, the third aspect of the disclosure relates to the processing method for the electrode for the resistance spot welding in which a projection portion and a plurality of recess portions are molded at an electrode tip portion of an electrode for the resistance spot welding bulging into a projecting shape according to transfer processing through the use of the processing tool for the electrode for welding. Moreover, the processing tool for the electrode for the resistance spot welding is equipped with a transfer processing unit that is configured to transfer the projection portion and the plurality of the recess portions at the electrode tip portion. The transfer processing unit is provided with a plurality of protrusions that are configured to mold the plurality of the recess portions. A virtual plane that links tips of the plurality of the protrusions with one another assumes a shape coinciding with a surface shape of the electrode tip portion bulging into the projecting shape before the transfer processing. The processing method for the electrode for the resistance spot welding includes carrying out transfer processing of the projection portion and the plurality of the recess portions at the electrode tip portion by pressing the electrode tip portion against the transfer processing unit of the processing tool for the electrode for the resistance spot welding.

According to this processing method for the electrode for the resistance spot welding as well, the respective protrusions substantially simultaneously come into contact with the respective portions of the electrode tip portion to mold the recess portions at the electrode tip portion, at the time of the transfer processing, as described previously. Therefore, the similar recess portions are molded over an extensive range of the electrode tip portion, and as a result, the height of the projection portion that is molded at the electrode tip portion can be guaranteed to be equal over an extensive range from the region of the central portion of this electrode tip portion to the region of the outer peripheral side thereof. Consequently, at the time of the resistance spot welding through the use of this electrode for the resistance spot welding, the film (e.g., the oxidation film) present on the surface of each of the metal plate materials can be destroyed over an extensive range, current can be kept from concentrating on part of each of the metal plate materials (current can be kept from concentrating on a weak region of the film in a state where the film is not destroyed), and the electrode tip portion can be restrained from melting and adhering to each of the metal plate materials.

In the disclosure, the transfer processing unit of the processing tool for the electrode for the resistance spot welding that is configured to mold the projection portion and the plurality of the recess portions, through transfer processing, at the electrode tip portion bulging into the projecting shape is provided with the plurality of the protrusions that are configured to mold the plurality of the recess portions respectively. The virtual plane that links the tips of the plurality of these protrusions with one another assumes the shape coinciding with the surface shape of the electrode tip portion bulging into the projecting shape before transfer processing. Thus, the similar recess portions can be molded over the extensive range of the electrode tip portion, and as a result, the height of the projection portion that is molded at the electrode tip portion can be guaranteed to be equal over the extensive range from the region of the central portion of this electrode tip portion to the region of the outer peripheral side thereof.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration view showing a welding gun of a resistance spot welding device according to one of the embodiments;

FIG. 2 is a view showing the schematic configuration of a control device of the welding gun;

FIG. 3 is a perspective view of an upper electrode as viewed from below;

FIG. 4 is a bottom view of the upper electrode;

FIG. 5 is a cross-sectional view along a line V-V in FIG. 4;

FIG. 6 is a plan view of a processing device for an electrode for welding;

FIG. 7 is a cross-sectional view along a line VII-VII in FIG. 6;

FIG. 8 is a plan view of a processing tool for the electrode for welding;

FIG. 9 is a lateral view of the processing tool for the electrode for welding;

FIG. 10 is a cross-sectional view along a line X-X in FIG. 8;

FIG. 11 is a perspective view showing one protrusion that is provided at a transfer processing unit of the processing tool for the electrode for welding;

FIG. 12 is a flowchart showing a procedure of a processing operation of an electrode tip portion;

FIG. 13 is a view showing a state of shaping of the electrode tip portion by a shaping device;

FIG. 14 is a view showing a transfer processing state of the electrode tip portion;

FIG. 15 is a view corresponding to FIG. 7 in a first modification example;

FIG. 16 is a plan view of a processing device for an electrode for welding in a second modification example;

FIG. 17 is a partially broken lateral view of the processing device for the electrode for welding in the second modification example;

FIG. 18 is a view corresponding to FIG. 8 in a third modification example; and

FIG. 19 is a view corresponding to FIG. 8 in a fourth modification example.

### DETAILED DESCRIPTION OF EMBODIMENTS

One of the embodiments of the disclosure will be described hereinafter based on the drawings. In the present embodiment, a case where the disclosure is applied as an electrode processing tool (a processing tool for an electrode for welding), a processing device for the electrode for welding, and a processing method for the electrode for welding for processing an electrode tip portion of the electrode (an electrode for resistance spot welding) for subjecting two aluminum alloy plate materials to resistance spot welding (which may be referred to hereinafter simply as welding) will be described.

The configuration of a resistance spot welding device and the configuration of the electrode will be described before describing the electrode processing tool, the processing device for the electrode for welding, and the processing method for the electrode for welding.

—Configuration of Resistance Spot Welding Device—

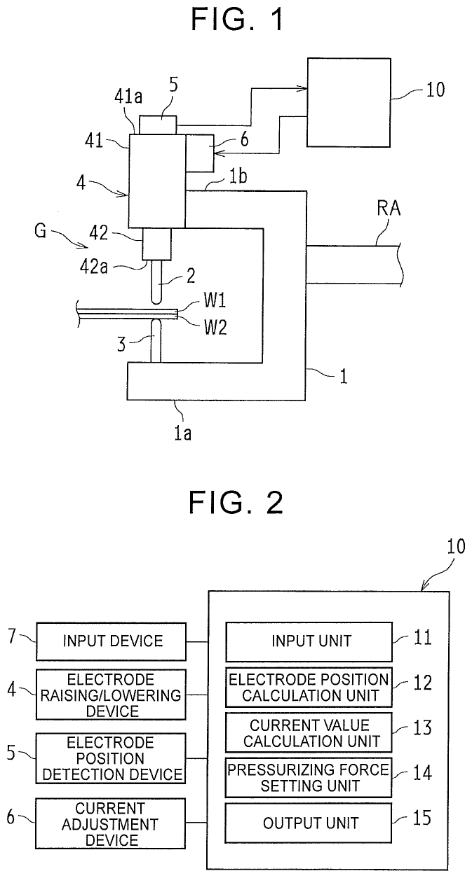

FIG. 1 is a schematic configuration view showing a welding gun G of the resistance spot welding device in which electrodes 2 and 3 according to the present embodiment are used. Besides, FIG. 2 is a view showing the schematic configuration of a control device 10 that is used to control the welding gun G.

The welding gun G is configured to include, as main components, a gun body 1 that is retained by a robot arm RA, the upper electrode 2, the lower electrode 3 that is erected at a lower portion 1a of the gun body 1, an electrically-operated upper electrode raising/lowering device (hereinafter referred to simply as an electrode raising/lowering device) 4 that retains and raises/lowers the upper electrode 2, an electrode position detection device 5, and a current adjustment device 6 that adjusts a value of welding current caused to flow between the upper electrode 2 and the lower electrode 3 (which may be referred to hereinafter simply as a current value). Incidentally, in FIGS. 1, W1 and W2 denote metal plate materials (aluminum alloy plate materials).

As shown in FIG. 1, the gun body 1 is a substantially U-shaped member, and the lower electrode 3 is removably erected on an upper surface of the lower portion 1a of the gun body 1. Besides, the electrode raising/lowering device 4 is mounted at a tip of an upper portion 1b of the gun body 1.

The electrode raising/lowering device 4 is equipped with a servomotor 41 that is mounted at the tip of the upper portion 1b of the gun body 1, and a raising/lowering member 42 that is linked with a drive shaft (not shown) of this servomotor 41. The upper electrode 2 is removably mounted at a lower end portion 42a of this raising/lowering member 42.

The electrode position detection device 5 is configured as, for example, an encoder, and is mounted at an upper end portion 41a of the servomotor 41. Moreover, a detection value of the electrode position detection device 5 is transmitted to the control device 10.

The current adjustment device 6 adjusts a value of current caused to flow between the upper electrode 2 and the lower electrode 3, in accordance with a current command value that is transmitted from the control device 10. As this current adjustment device 6, a well-known device, for example, a device that is equipped with a variable resistor, a device that is equipped with a converter, or the like is applied.

The control device 10 is equipped, as main units, with an input unit 11 that acquires information from an input device 7 (see FIG. 2) to which plate thicknesses of the metal plate materials W1 and W2 and the like are input, an electrode position calculation unit 12 that calculates an electrode position from a detection value of the electrode position detection device 5, a current value calculation unit 13 that calculates a current value in carrying out energization between the upper electrode 2 and the lower electrode 3, a pressurizing force setting unit 14 that sets a pressurizing force necessary for welding (a pressurizing force applied to the metal plate materials W1 and W2 by the upper electrode 2 and the lower electrode 3), and an output unit 15 that outputs information on the current value calculated by the current value calculation unit 13 and information on the pressurizing force set by the pressurizing force setting unit 14.

This control device 10 is realized by storing a program corresponding to a relevant function into a ROM, in a unit that is mainly composed of a CPU and that is equipped with the ROM, a RAM, an input/output interface, and the like. Besides, the detection value from the electrode position detection device 5 and information on the plate thicknesses and the like are temporarily stored into the RAM. Incidentally, the control device 10 is identical in other configurational details to those conventionally used for the welding gun G; so detailed description thereof will be omitted.

—Configuration of Electrodes—

Next, the configuration of each of the electrodes 2 and 3 that is obtained by processing an electrode tip portion by a later-described electrode processing tool 200 (see FIG. 8) as a feature of the present embodiment will be described. That is, the present embodiment is characterized in the configuration of the electrode processing tool 200 for molding each of the electrodes 2 and 3 configured as follows.

The upper electrode 2 and the lower electrode 3 are identical in configuration to each other. Therefore, the upper electrode 2 will now be described as a representative of both the electrodes.

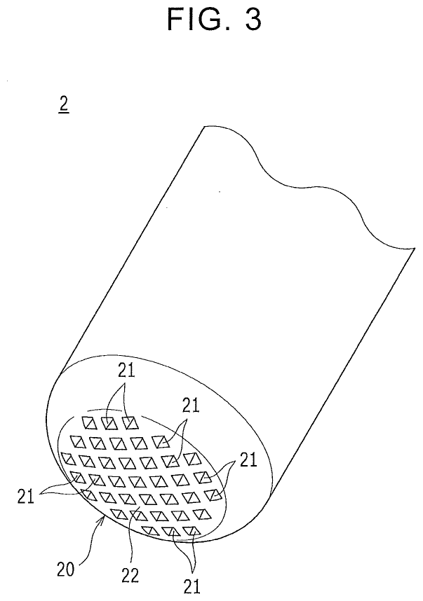

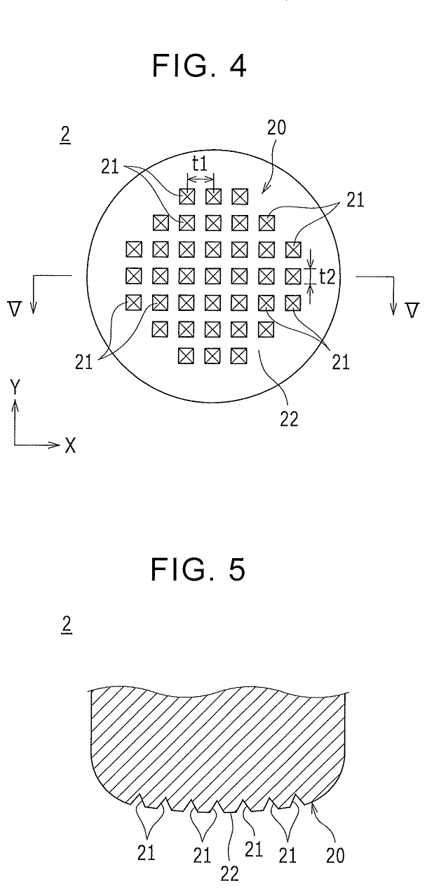

FIG. 3 is a perspective view of the upper electrode 2 as viewed from below. FIG. 4 is a bottom view of the upper electrode 2. FIG. 5 is a cross-sectional view along a line V-V in FIG. 4.

This upper electrode 2 is configured as a copper material in which a copper alloy such as Cu—Cr, Cu—Cr—Zr or the like, and a hard material such as Al₂O₃ or the like are dispersed.

As shown in FIGS. 3 to 5, the upper electrode 2 is a substantially cylindrical member, and an electrode tip portion 20 for holding the metal plate materials W1 and W2 assumes the shape of a substantially spherical projection having a predetermined curvature radius (e.g., a curvature radius that is set between 40 mm and 350 mm). Besides, this upper electrode 2 has an outer diameter that is set in advance in accordance with a target nugget diameter at the time of welding.

Moreover, this electrode tip portion 20 is provided with recess portions 21 and a projection portion 22. These recess portions 21 and this projection portion 22 will be described hereinafter.

As a method of molding these recess portions 21 and this projection portion 22, molding according to transfer processing through the use of the electrode processing tool (referred to also as a transfer plate) 200, which will be described later, is carried out. That is, this electrode processing tool 200 is provided with a plurality of protrusions 211 (see FIG. 8) for molding the recess portions 21. The recess portions 21 are molded by pressing the electrode tip portion (the electrode tip portion assuming the shape of the substantially spherical projection as described previously) 20 of the upper electrode 2 where the recess portions 21 have not been molded or the electrode tip portion 20 of the upper electrode 2 that has been abraded by being used for resistance spot welding against the electrode processing tool 200, and transferring (carrying out transfer processing of) the shapes of the protrusions 211 on the electrode processing tool 200 onto the electrode tip portion 20. The region other than these recess portions 21 is molded as the projection portion 22.

The plurality of the recess portions 21 are independent of one another, and are disposed at the electrode tip portion 20 in a dispersed manner. These recess portions 21 are disposed (arranged) in a plurality of rows along a lateral direction (an X-direction) and a vertical direction (a Y-direction) in FIG. 4. In concrete terms, three of the recess portions 21 are disposed along the vertical direction (the Y-direction) in the first row at a right end in the lateral direction (the X-direction) in FIG. 4. Besides, three of the recess portions 21 are disposed along the vertical direction (the Y-direction) in the seventh row at a left end in the lateral direction (the X-direction) as well. Besides, five of the recess portions 21 are disposed along the vertical direction (the Y-direction) in the second row at the second position from the right end in the lateral direction (the X-direction). Besides, five of the recess portions 21 are disposed along the vertical direction (the Y-direction) in the sixth row at the second position from the left end in the lateral direction (the X-direction) as well. Moreover, seven of the recess portions 21 are disposed along the vertical direction (the Y-direction) in each of the other rows (the third to fifth rows) in the lateral direction (the X-direction). Besides, the central one of the seven recess portions 21 in the fourth row (the fourth recess portion 21 from above in the Y-direction) is located on a centerline of the upper electrode 2 (at a center of the electrode tip portion 20).

Each of the recess portions 21 is molded as a recess portion assuming the shape of a quadrangular pyramid. Each of the recess portions 21 is configured such that an outer edge shape (a square outer edge shape) thereof on a cross-section in a direction perpendicular to the centerline of the upper electrode 2 (the electrode centerline) gradually decreases in area (area of the square) toward a depth direction of each of the recess portions 21. Besides, each of the recess portions 21 is disposed such that respective sides of the square extend along the X-direction and the Y-direction. Furthermore, each of the recess portions 21 is shaped such that the centerline thereof (a straight line extending in a direction perpendicular to a virtual bottom surface of the quadrangular pyramid) extends along a direction along the centerline of the upper electrode 2 (a direction in which the upper electrode 2 is raised/lowered by the electrode raising/lowering device 4).

Besides, those of the recess portions 21 which are adjacent to each other are spaced apart from each other by the same distance in both the lateral direction (the X-direction) and the vertical direction (the Y-direction) in FIG. 4. Furthermore, the outermost ones of these recess portions 21 (which are located beside the outer edge portion of the electrode tip portion 20) are located inside, apart from the outer edge portion of the electrode tip portion 20 by the predetermined dimension. No recess portion is provided at the outer edge portion of this electrode tip portion 20.

The projection portion 22 is a region other than regions where the recess portions 21 are provided, and is configured to be equipped with a continuous surface that continues in regions among the plurality of the recess portions 21 without being divided by the recess portions 21. That is, the entire region of the electrode tip portion 20 where the plurality of the recess portions 21 are not provided is configured as the projection portion 22. As described previously, the electrode tip portion 20 assumes the shape of the substantially spherical projection having the predetermined curvature radius. Therefore, this projection portion 22 has a surface that also assumes the shape of a substantially spherical projection having a predetermined curvature radius. That is, the upper electrode 2 is formed as a projecting curved surface bulging (protruded) most at a position on the centerline thereof (on the electrode centerline), and is shaped such that the bulging amount (the protrusion amount) thereof gradually decreases toward an outer peripheral side thereof.

A concrete example of the dimensions of the recess portions 21 will now be described. The following respective dimensions are applied to a general electrode for resistance spot welding (e.g., an electrode for resistance spot welding that has an outer diameter of about 15 mm).

The depth of each of the recess portions 21 is set within a range that is equal to or greater than 30 μm and equal to or smaller than 150 μm. Besides, the distance (a pitch; a dimension t1 in FIG. 4) between central positions of those of the recess portions 21 which are adjacent to each other (adjacent to each other in the X-direction or the Y-direction) is set within a range that is equal to or longer than 400 μm and equal to or shorter than 1200 μm. Besides, the length (a dimension t2 in FIG. 4) of one side of the opening end of each of the recess portions 21 is set within a range that is equal to or longer than 80 μm and equal to or shorter than 350 μm.

—Processing Device for Electrode for Welding and Processing Tool for Electrode—

Next, the processing device for the electrode for welding as the feature of the present embodiment, and the processing tool with which the processing device for the electrode for welding is equipped will be described.

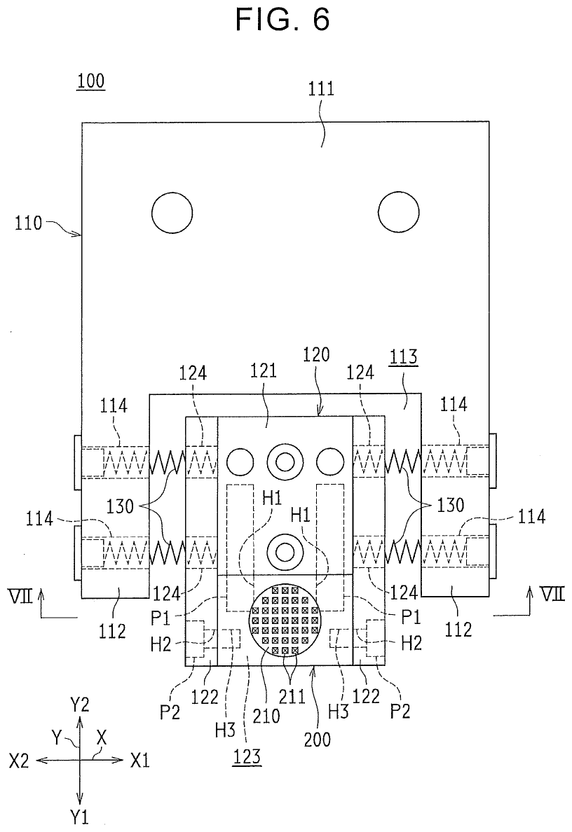

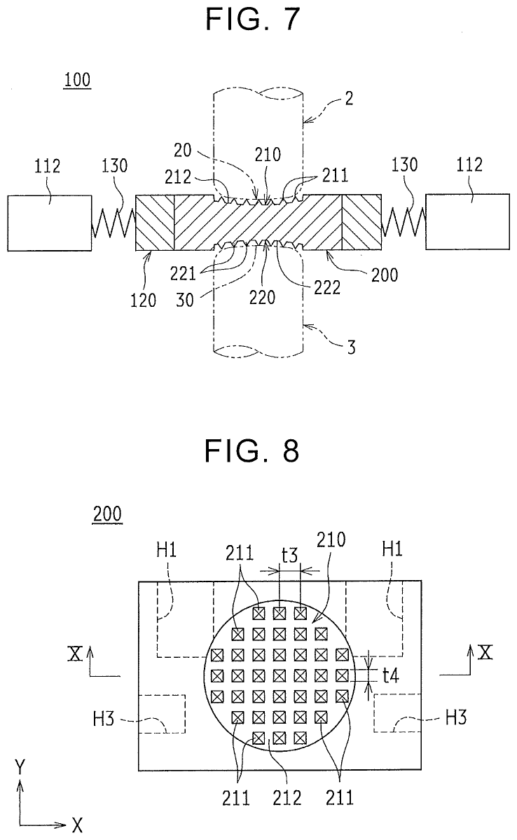

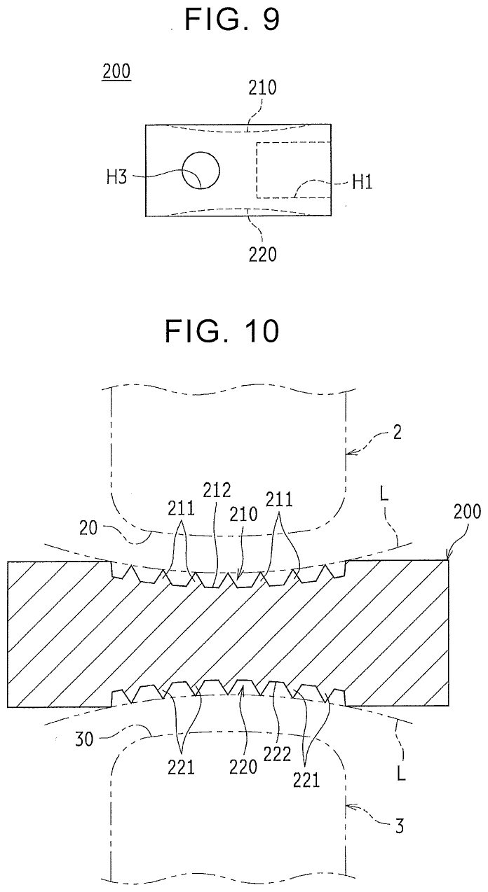

FIG. 6 is a plan view of a processing device 100 for an electrode for welding. FIG. 7 is a cross-sectional view along a line VII-VII in FIG. 6. Besides, FIG. 8 is a plan view of a processing tool 200 for the electrode. FIG. 9 is a lateral view of the processing tool 200 for the electrode (the shape of the protrusions 211 is not depicted in this FIG. 9). In the following description, as shown in FIG. 6, a width direction of the processing device 100 for the electrode for welding will be referred to as an X-direction, and a depth direction of the processing device 100 will be referred to as a Y-direction. Besides, a rightward direction in FIG. 6 along the X-direction will be referred to as an X1-direction, and a leftward direction in FIG. 6 along the X-direction will be referred to as an X2-direction. Besides, a downward direction in FIG. 6 along the Y-direction will be referred to as a Y1-direction (a forward direction), and an upward direction in FIG. 6 along the Y-direction will be referred to as a Y2-direction (a backward direction).

As shown in FIGS. 6 and 7, the processing device 100 for the electrode for welding is equipped with a device body 110, an electrode processing tool holder 120, and an electrode processing tool 200.

The device body 110 is fixed on a base (not shown), and is equipped with a base portion 111 that is rectangular in a plan view, and a pair of arm portions 112 that extend in the Y1-direction from both end regions of the base portion 111 in the X-direction (the lateral direction). A space between these arm portions 112 is a holder retention space 113 for retaining the electrode processing tool holder 120.

The electrode processing tool holder 120 is disposed in the holder retention space 113, and is equipped with a holder base portion 121 and a pair of holder arm portions 122 that extend in the Y1-direction from both end regions of the holder base portion 121 in the X-direction (the lateral direction) on the Y2-direction side. A space between these holder arm portions 122 is a processing tool retention space 123 for retaining the electrode processing tool 200.

Besides, this electrode processing tool holder 120 is elastically supported (elastically retained) with respect to the device body 110, by a plurality of coil springs (which can be regarded as the elastic body in the disclosure) 130.

In concrete terms, recessed cave portions 114 into which the coil springs 130 are inserted to be supported are provided, at two locations, in a lateral surface of the device body 110 inside the arm portions 112 respectively. Besides, similar recessed cave portions 124 into which the coil springs 130 are inserted to be supported are provided in a lateral surface of the electrode processing tool holder 120 outside the holder base portion 121, at positions opposite the recessed cave portions 114 respectively. Moreover, both end portions of the coil springs 130 are individually fitted along the recessed cave portions 114 that are provided in the arm portions 112, and the recessed cave portions 124 that are provided in the holder base portion 121, respectively. Thus, the electrode processing tool holder 120 is elastically supported with respect to the device body 110.

As shown in FIGS. 8 and 9, the electrode processing tool 200 is a rectangular parallelepiped member, and a central portion of an upper surface of the electrode processing tool 200 and a central portion of a lower surface of the electrode processing tool 200 are configured as transfer processing units 210 and 220 respectively. These transfer processing units 210 and 220 are circular in a plan view. The outer diameter of each of the transfer processing units 210 and 220 is set equal to or slightly larger than the outer diameter of each of the electrodes 2 and 3. The upper transfer processing unit 210 as the upper surface is a region for molding the recess portions 21 and the projection portion 22 at the electrode tip portion 20 of the upper electrode 2. On the other hand, the lower transfer processing unit 220 as the lower surface is a region for molding the recess portions 21 and the projection portion 22 at the electrode tip portion 30 (see FIG. 10) of the lower electrode 3.

Besides, the dimension of the electrode processing tool 200 in the width direction (the X-direction) substantially coincides with the distance between the respective holder arm portions 122 of the electrode processing tool holder 120 (the dimension of the processing tool retention space 123 in the X-direction). Besides, the dimension of the electrode processing tool 200 in the depth direction (the Y-direction) substantially coincides with the length (the dimension in the Y-direction) of the respective holder arm portions 122 of the electrode processing tool holder 120.

Moreover, two knock pins P1 are provided in a protrusive manner on a surface of the holder base portion 121 of the electrode processing tool holder 120 in the Y1 direction (on the front side), and pin holes H1 are formed in a surface of the electrode processing tool 200 on a depth side (a surface thereof on the Y2-direction side) in such a manner as to correspond to the positions of these knock pins P1 respectively. Moreover, the electrode processing tool 200 is mounted on the electrode processing tool holder 120 such that the knock pins P1 are inserted into these pin holes H1 respectively. Besides, positioning holes H2 that penetrate in the X-direction are formed in the holder arm portions 122 of the electrode processing tool holder 120 respectively, and pin holes H3 are formed in both lateral surfaces of the electrode processing tool 200 in the X-direction, in such a manner as to correspond to the positions of these positioning holes H2 respectively. Then, the electrode processing tool 200 is positioned with respect to the electrode processing tool holder 120 through the insertion of the knock pins P2 into these holes H2 and H3 with these positioning holes H2 and these pin holes H3 positioned with respect to each other respectively. Because this positioning by the knock pins P2 is carried out, the electrode processing tool 200 can be easily removed from the electrode processing tool holder 120 by removing these knock pins P2, and the operation of replacing the electrode processing tool 200 can be simplified. Incidentally, the electrode processing tool 200 should not necessarily be positioned with respect to this electrode processing tool holder 120 by the knock pins P2, but this positioning may be realized through the combination of a key groove and a key.

Next, the configuration of the transfer processing units 210 and 220 as the feature of the present embodiment will be described. These transfer processing units 210 and 220 are identical in configuration to each other, so the upper transfer processing unit 210 will now be described as an example.

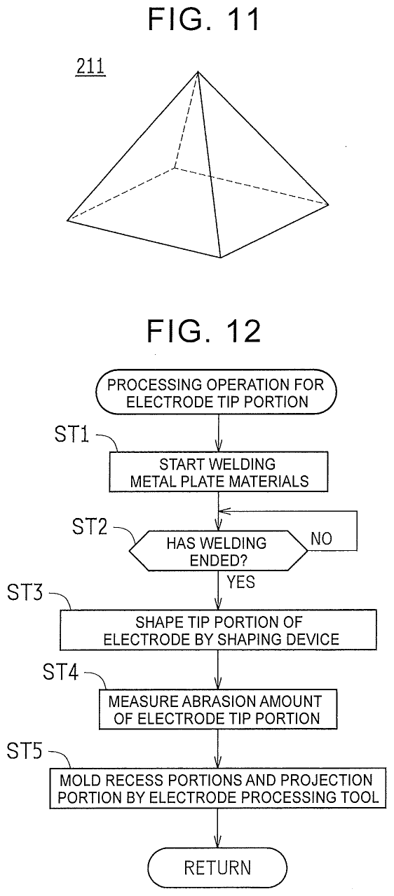

FIG. 10 is a cross-sectional view along a line X-X in FIG. 8. Besides, FIG. 11 is a perspective view showing one of the protrusions 211 provided on the transfer processing unit 210.

As shown in these drawings, the transfer processing unit 210 is provided with the plurality of the protrusions 211 for molding the recess portions 21 respectively. Moreover, the region other than the plurality of these protrusions 211 is molded as a recess portion 212 for molding the projection portion 22. Therefore, the surface of this recess portion 212 can be regarded as “the bottom surface of the transfer processing unit (the bottom surface as the region other than the regions of the transfer processing unit where the plurality of the protrusions are provided) of the disclosure.

The plurality of the protrusions 211, which are independent of one another, are disposed in a dispersed manner on the transfer processing unit 210. These protrusions 211 are disposed (arranged) in a plurality of rows along the lateral direction (the X-direction) and the vertical direction (the Y-direction) in FIG. 8 respectively. In concrete terms, the protrusions 211 are provided in the same arrangement as the recess portions 21 of the electrode tip portion 20 described through the use of FIG. 4. That is, three of the protrusions 211 are disposed along the vertical direction (the Y-direction) in the first row at the right end in the lateral direction (the X-direction) in FIG. 8. Besides, three of the protrusions 211 are disposed along the vertical direction (the Y-direction) in the seventh row at the left end in the lateral direction (the X-direction) as well. Besides, five of the protrusions 211 are disposed along the vertical direction (the Y-direction) in the second row at the second position from the right end in the lateral direction (the X-direction). Besides, five of the protrusions 211 are disposed along the vertical direction (the Y-direction) in the sixth row at the second position from the left end in the lateral direction (the X-direction) as well. Moreover, seven of the protrusions 211 are disposed along the vertical direction (the Y-direction) in each of the other rows (the third to fifth rows) in the lateral direction (the X-direction). Besides, the central one (the fourth one from above in the Y-direction) of the seven protrusions 211 in the fourth row is located on a centerline of the transfer processing unit 210. As described hitherto, the plurality of the protrusions 211 are disposed in a dispersed manner on the transfer processing unit 210, at positions that are point-symmetric with respect to a central position of the transfer processing unit 210.

As shown in FIG. 11 as well, each of the protrusions 211 assumes the shape of a quadrangular pyramid (the shape of a quadrangular pyramid that is tapered toward a tip side thereof). Besides, each of the protrusions 211 is disposed such that respective sides of a square as the shape of a bottom surface of each of the protrusions 211 extend along the X-direction and the Y-direction. Furthermore, each of the protrusions 211 is shaped such that the centerline thereof (a straight line extending in the direction perpendicular to the bottom surface of the quadrangular pyramid) extends in the direction along the plate thickness direction of the electrode processing tool 200.

Besides, the distance between those of the protrusions 211 which are adjacent to each other is the same both in the lateral direction (the X-direction) and in the vertical direction (the Y-direction).

Moreover, the plurality of these protrusions 211 are characterized in that a virtual plane that links tips of the plurality of these protrusions 211 with one another (a virtual plane indicated by an alternate long and two short dashes line L in FIG. 10) assumes a shape substantially coinciding with a surface shape of each of the electrode tip portions 20 and 30 of the electrodes 2 and 3 (a surface shape bulging in a projecting manner) before transfer processing.

As described previously, each of the electrode tip portions 20 and 30 assumes the shape of a substantially spherical projection having a predetermined curvature radius (e.g., a curvature radius that is set between 40 mm and 350 mm). Therefore, a virtual plane L that links the tips of the plurality of the protrusions 211 with one another assumes the shape of a substantially spherical recess having substantially the same curvature radius (e.g., a curvature radius that is set between 40 mm and 350 mm). That is, each of the electrodes 2 and 3 is formed as a projecting curved surface bulging (protruded) most at the position on the centerline of each of the electrode tip portions 20 and 30 (on the electrode centerline), and accordingly, the virtual plane (the virtual plane that links the tips of the plurality of the protrusions 211 with one another) L is formed as a recessed curved surface recessed most at the position on the centerline thereof.

The recess portion 212 is a region other than regions where the protrusions 211 are provided, and is configured to be equipped with a continuous surface that continues in regions among the plurality of the protrusions 211 without being divided by the protrusions 211. That is, the entire region of the transfer processing unit 210 where the plurality of the protrusions 211 are not provided is configured as the recess portion 212.

Moreover, this recess portion 212 assumes a shape substantially coinciding with the shape of the electrode tip portion 20 (the shape of the projection portion 22 at the electrode tip portion 20). That is, the electrode tip portion 20 assumes the shape of a substantially spherical projection having a predetermined curvature radius (e.g., a curvature radius that is set between 40 mm and 350 mm), so the recess portion 212 assumes the shape of a substantially spherical recess having substantially the same curvature radius (e.g., a curvature radius that is set between 40 mm and 350 mm). That is, each of the electrodes 2 and 3 is formed as a projecting curved surface bulging (protruded) most at the position on the centerline of each of the electrode tip portions 20 and 30 (on the electrode centerline), and accordingly, the recess portion 212 of the transfer processing unit 210 is formed as a recessed curved surface recessed most at the position on the centerline thereof.

An example of concrete dimensions of the protrusions 211 will now be described. The following respective dimensions are applied in processing a general electrode for resistance spot welding (e.g., whose outer diameter is about 15 mm).

The height of each of the protrusions 211 is set within a range that is equal to or higher than 30 μm and equal to or lower than 150 μm. Besides, the distance between central positions of those of the protrusions 211 which are adjacent to each other (adjacent to each other in the X-direction or the Y-direction) (a pitch; a dimension t3 in FIG. 8) is set within a range that is equal to or longer than 400 μm and equal to or shorter than 1200 μm. Besides, the length of one side of a bottom surface of each of the protrusions 211 (a dimension t4 in FIG. 8) is set within a range that is equal to or longer than 80 μm and equal to or shorter than 350 μm.

The reason why the respective dimensions are thus set will be described. In the case where the height of each of the protrusions 211 is lower than 30 μm, an oxidation film present on the surface of each of the metal plate materials W1 and W2 cannot be sufficiently destroyed due to an insufficiency in the protrusion amount (height) of the projection portion 22 that is molded at the electrode tip portion 20, and the adhesion through melting may be caused. In the case where the height of each of the protrusions 211 is higher than 150 μm, the protrusions 211 may be damaged in molding the recess portions 21 at the electrode tip portion 20. In the case where the distance between the central positions of those of the protrusions 211 which are adjacent to each other is shorter than 400 μm, it is difficult to prepare the electrode processing tool 200, and furthermore, the amount of energy needed to obtain the target nugget diameter at the time of welding significantly increases. In the case where the distance between the central positions of those of the protrusions 211 which are adjacent to each other is longer than 1200 μm, the oxidation film cannot be sufficiently destroyed due to too large a contact area between the electrode tip portion 20 and each of the metal plate materials W1 and W2, and the adhesion through melting may be caused. In the case where the length of one side of the bottom surface of each of the protrusions 211 is shorter than 80 μm, the protrusions 211 may be damaged in molding the recess portions 21 at the electrode tip portion 20. In the case where the length of one side of the bottom surface of each of the protrusions 211 is longer than 350 μm, the local concentration of current is promoted due to too small a contact area between each of the metal plate materials W1 and W2 and the electrode tip portion 20, and the adhesion through melting may be caused. The respective dimensions are set in consideration of the foregoing points.

Besides, as the material of the electrode processing tool 200, it is possible to mention a material that is harder than the material of the electrodes 2 and 3, for example, super steel, high-speed steel (high-speed tool steel), tool steel, carbon steel, or the like. Besides, as a method of processing the electrode processing tool 200 into the foregoing shape, it is possible to mention electric discharge machining, cutting work, pressing work, knurling, molding by a 3D printer, or the like. Besides, it is preferable to subject the electrode processing tool 200 to a surface treatment. As this surface treatment, it is possible to mention physical vapor deposition (PVD), chemical vapor deposition (CVD), nitriding, carbonization, or the like.

As described previously, the lower transfer processing unit 220 is identical in configuration to the upper transfer processing unit 210. In FIGS. 7 and 10, the protrusions and the recess portions of this lower transfer processing unit 220 are denoted by 221 and 222 respectively.

—Processing Operation of Electrode Tip Portion—

Next, the processing operation of the electrode tip portion 20 through the use of the electrode processing tool 200 configured as described previously will be described. FIG. 12 is a flowchart showing the procedure of the processing operation of this electrode tip portion 20. A case where the recess portions 21 and the projection portion 22 are molded at each of the electrode tip portions 20 and 30 through the use of the electrode processing tool 200 for each of the electrodes 2 and 3 after welding is carried out by each of the electrodes 2 and 3 at which the recess portions 21 and the projection portion 22 have already been molded will be described. That is, a case where the recess portions 21 and the projection portion 22 are molded into suitable shapes through the use of the electrode processing tool 200 and each of the electrodes 2 and 3 is used again for welding from a state where the recess portions 21 and the projection portion 22 that are molded at each of the electrode tip portions 20 and 30 are deformed (have lost shape) due to welding will be described.

First of all, after the welding of the metal plate materials W1 and W2 is started (step ST1), it is determined in step ST2 whether or not the welding has ended. For example, it is determined that the welding has ended as soon as a predetermined time elapses since the start of the welding (since the metal plate materials W1 and W2 are held by the pair of the electrodes 2 and 3 respectively and energization thereof is started at a predetermined current value).

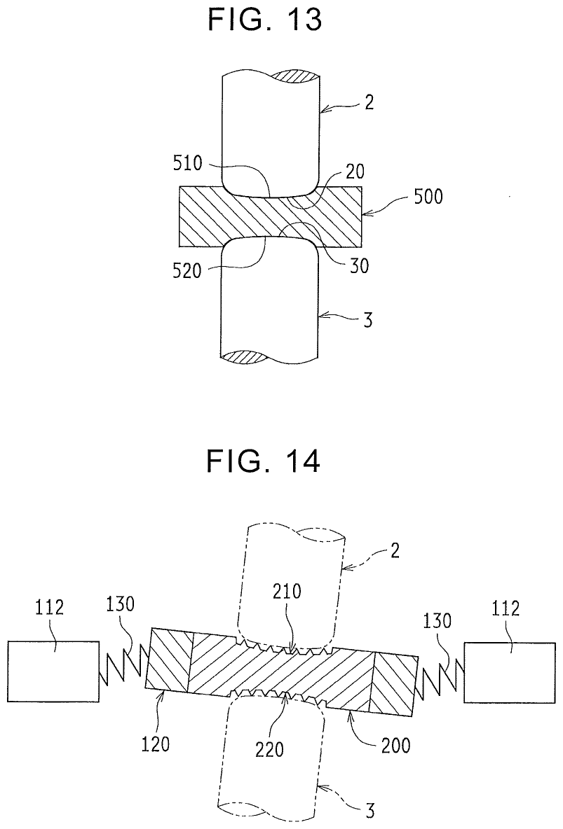

If the result of step ST2 becomes YES after the end of the welding, a transition to step ST3 is made. As shown in FIG. 13, a shaping device 500 with which the processing device 100 for the electrode for welding is equipped performs the shaping (the shaping operation) of the electrode tip portions 20 and 30. Each of shaping units 510 and 520 of the shaping device 500 is a recess portion for shaping each of the electrode tip portions 20 and 30 into a substantially spherical portion having a predetermined curvature radius (e.g., a curvature radius that is set between 40 mm and 350 mm). Each of the electrode tip portions 20 and 30 is pressed against each of these shaping units 510 and 520 at a predetermined pressure. Thus, each of the electrode tip portions 20 and 30 is shaped into a substantially spherical projection having a predetermined curvature radius.

After each of the electrode tip portions 20 and 30 is thus shaped, a transition to step ST4 is made to measure an abrasion amount of each of the electrode tip portions 20 and 30. That is, the abrasion amount of each of the electrode tip portions 20 and 30 resulting from the welding in the foregoing step ST1 is measured. As a method of measuring this abrasion amount, a reference plate (not shown) whose plate thickness coincides with that of each of the metal plate materials W1 and W2 is held by the respective electrodes 2 and 3, and a difference (a difference corresponding to the abrasion amount) between an electrode position calculated by the electrode position calculation unit 12 at this time and an electrode position calculated last time is measured as the abrasion amount of each of the electrode tip portions 20 and 30.

After that, a transition to step ST5 is made, and the operation of processing each of the electrode tip portions 20 and 30 by the electrode processing tool 200, namely, the molding (transfer processing) of the plurality of the recess portions 21 and the projection portion 22 by pressing each of the electrode tip portions 20 and 30 against each of the transfer processing units 210 and 220 of the electrode processing tool 200 is carried out. At this time, the electrode processing tool 200 is clamped by the pair of the electrodes 2 and 3, but the pressure (the clamping force) at this time is set higher than the pressure at the time of resistance spot welding that will be described later (e.g., set higher than the pressure at the time of resistance spot welding by about 20%). This clamping force is not limited to this value, but may be equal to the clamping force corresponding to the pressure at the time of resistance spot welding.

FIG. 14 shows an example of the state of transfer processing at this time. This FIG. 14 shows a case where each of the electrodes 2 and 3 diagonally comes into contact with the electrode processing tool 200 at the time of transfer processing. Even in this situation, as shown in FIG. 14, the electrode processing tool holder 120 is supported (held) by the coil springs 130. Therefore, the posture of the electrode processing tool 200 changes due to elastic deformation of the coil springs 130, and each of the transfer processing units 210 and 220 extends in the direction perpendicular to the direction in which each of the electrodes 2 and 3 moves. Thus, the recess portions 21 and the projection portion 22 of each of the electrode tip portions 20 and 30 can be molded well by each of the transfer processing units 210 and 220.

After that, welding by the electrodes 2 and 3 where the recess portions 21 and the projection portion 22 are thus molded is started (step ST1). The foregoing operation is repeated.

—At Time of Resistance Spot Welding—

Next, the time of resistance spot welding through the use of the upper electrode 2 processed as described previously and the lower electrode 3 configured in the same manner as the upper electrode 2 (the operation in the foregoing step ST1) will be described.

At the time of resistance spot welding by holding the metal plate materials W1 and W2 by these electrodes 2 and 3, when the metal plate materials W1 and W2 are held by these electrodes 2 and 3, the oxidation film present on the surface of each of the metal plate materials W1 and W2 is destroyed over an extensive range by the projection portion 22. That is, each of the electrode tip portions 20 and 30 is provided with the plurality of the recess portions 21, and is partially in contact with each of the metal plate materials W1 and W2 (only the projection portion 22 is in contact with each of the metal plate materials W1 and W2). Therefore, the stress in the region of each of the metal plate materials W1 and W2 with which the projection portion 22 is in contact is enhanced, and the oxidation film is destroyed over an extensive range.

In the case where the oxidation film has not been destroyed, current concentrates on the weak region of the oxidation film at the time of welding, and each of the electrode tip portions may melt and adhere to each of the metal plate materials as a result of a local rise in temperature. In contrast, according to the present embodiment, the oxidation film is destroyed over an extensive range, so current can be kept from concentrating on part of each of the metal plate materials W1 and W2, and each of the electrode tip portions 20 and 30 can be restrained from melting and adhering to each of the metal plate materials W1 and W2.

Then, with the metal plate materials W1 and W2 held by the electrodes 2 and 3 as described previously, energization is carried out between the electrodes 2 and 3, the metal plate materials W1 and W2 are partially melted to form nuggets, and the respective metal plate materials W1 and W2 are joined to each other. In this case, the plurality of the recess portions 21 that are provided at each of the electrode tip portions 20 and 30 are independent of one another, and are disposed in a dispersed manner at each of the electrode tip portions 20 and 30. Therefore, the current paths can be restrained from being enlarged (the current paths can be restrained from being enlarged in the direction perpendicular to the plate thickness direction of each of the metal plate materials W1 and W2) due to the fringing phenomenon at the projection portion 22, and a high current density can be ensured in each of the current paths. Therefore, the respective metal plate materials W1 and W2 can be joined to each other by efficiently melting the metal plate materials W1 and W2 while keeping the current value (the welding current value) low. Besides, this projection portion 22 is the region other than the regions where the recess portions 21 are provided, and hence reaches the outer edge portion of the electrode tip portion 20. That is, a contact range that is sufficient to obtain the target nugget diameter is ensured. As a result, the amount of energy needed to obtain the target nugget diameter can be curtailed.

### Effect of Embodiment

As described above, in the present embodiment, each of the transfer processing units 210 and 220 of the electrode processing tool 200 for molding, through transfer processing, the projection portion 22 and the plurality of the recess portions 21 at each of the electrode tip portions 20 and 30 bulging into the projecting shape is provided with the plurality of the protrusions 211 for molding the plurality of the recess portions 21, and the virtual plane L that links the tips of the plurality of these protrusions 211 with one another assumes the shape coinciding with the surface shape of each of the electrode tip portions 20 and 30 bulging into the projecting shape before transfer processing. Thus, the similar recess portions 21 can be molded over an extensive range of the electrode tip portion 20, and as a result, the height of the projection portion 22 that is molded at each of the electrode tip portions 20 and 30 can be guaranteed to be equal over an extensive range from the region of the central portion of each of these electrode tip portions 20 and 30 to the region on the outer peripheral side thereof. As a result, at the time of welding through the use of these electrodes 2 and 3, the oxidation film present on the surface of each of the metal plate materials W1 and W2 can be destroyed over an extensive range, current can be kept from concentrating on part of each of the metal plate materials W1 and W2 (current can be kept from concentrating on the weak region of the oxidation film in the state where the oxidation film is not destroyed), and each of the electrode tip portions 20 and 30 can be restrained from melting and adhering to each of the metal plate materials W1 and W2.

Besides, in the present embodiment, the bottom surface (each of the recess portions 212 and 222) as the region other than the regions where the plurality of the protrusions 211 are provided at each of the transfer processing units 210 and 220 also assumes the shape coinciding with the surface shape of each of the electrode tip portions 20 and 30 bulging into the projection shape before transfer processing. At the time of transfer processing of each of the electrode tip portions 20 and 30 by the electrode processing tool 200, the recess portions 21 are molded at each of the electrode tip portions 20 and 30, so each of the electrode tip portions 20 and 30 may deform (the material may flow toward the outer peripheral side thereof) as a result. However, the bottom surface of each of the transfer processing units 210 and 220 assumes the shape coinciding with the surface shape of each of the electrode tip portions 20 and 30 bulging into the projecting shape before transfer processing. Therefore, each of these electrode tip portions 20 and 30 is restrained from deforming (the material is restrained from flowing toward the outer peripheral side thereof), and the shape of each of the electrode tip portions 20 and 30 after transfer processing (the projecting shape into which each of the electrode tip portions 20 and 30 has bulged) is maintained well. Besides, in the case where this configuration is adopted, each of the electrode tip portions 20 and 30 reaches the bottom surface of each of the transfer processing units 210 and 220, and each of the electrode tip portions 20 and 30 is thus shaped into a predetermined shape (the shape thereof is arranged). Accordingly, the shaping operation by the foregoing shaping device 500 can also be dispensed with.

Besides, each of the protrusions 211 assumes the shape of a cone that is tapered toward the tip side thereof (the shape of a quadrangular pyramid). Therefore, at the time of transfer processing of each of the electrode tip portions 20 and 30 by the electrode processing tool 200, each of the protrusions 211 is likely to bite into each of the electrode tip portions 20 and 30, and a sufficient depth of the recess portions 21 that are molded at each of the electrode tip portions 20 and 30 can be ensured. That is, the oxidation film present on the surface of each of the metal plate materials W1 and W2 can be destroyed well at the time of welding, by ensuring a sufficient height of the projection portion 22 that is molded at each of the electrode tip portions 20 and 30.

Besides, the centerline of each of the protrusions 211 extends in the direction along the centerline of each of the electrodes 2 and 3 at the time of transfer processing. Therefore, at the time of transfer processing of each of the electrode tip portions 20 and 30 by the electrode processing tool 200, each of the protrusions 211 of the electrode processing tool 200 bites well into each of the electrode tip portions 20 and 30, and a sufficient depth of the recess portions 21 that are molded at each of the electrode tip portions 20 and 30 can be ensured. That is, according to this configuration as well, the oxidation film present on the surface of each of the metal plate materials W1 and W2 can be destroyed well at the time of welding, by ensuring a sufficient height of the projection portion 22 that is molded at each of the electrode tip portions 20 and 30.

Besides, the plurality of the protrusions 211 are disposed in a dispersed manner at each of the transfer processing units 210 and 220, at the positions that are point-symmetric with respect to the central position of each of the transfer processing units 210 and 220. Therefore, at the time of welding by each of the electrodes 2 and 3 having the electrode tip portions 20 and 30 where the projection portion and the recess portions are molded by the electrode processing tool 200, the distribution of the current flowing through each of the metal plate materials W1 and W2 can be made uniform. Therefore, current can be restrained from concentrating locally, an odd-shaped nugget can be restrained from being formed, and the reliability can be enhanced in obtaining the target nugget diameter.

### First Modification Example

Next, a first modification example will be described. The present modification example is different in the configuration of the processing device 100 for the electrode for welding from the foregoing embodiment. Only what is different from the foregoing embodiment will be described hereinafter.

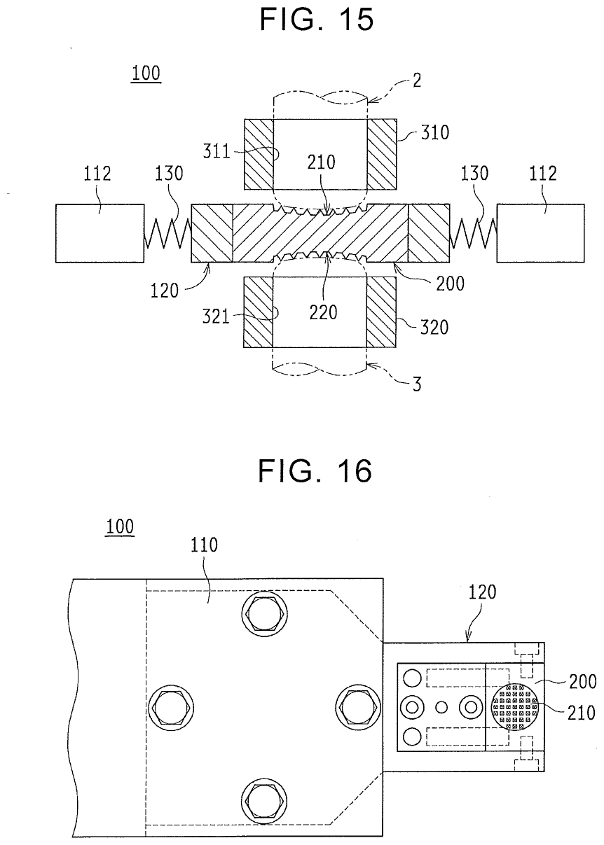

FIG. 15 is a view corresponding to FIG. 7 in the present modification example. As shown in this FIG. 15, the processing device 100 for the electrode for welding in the present modification example has guide members 310 and 320 disposed above the upper transfer processing unit 210 of the electrode processing tool 200 and below the lower transfer processing unit 220 of the electrode processing tool 200 respectively. Each of these guide members 310 and 320 is a metal member, and each of guide holes 311 and 321 that penetrate in the vertical direction and are circular in a plan view is formed through a central portion thereof. The inner diameter of each of these guide holes 311 and 321 substantially coincides with the outer diameter of each of the electrodes 2 and 3. Besides, a central axis of each of these guide holes 311 and 321 coincides with a central position of each of the transfer processing units 210 and 220 (a central position with no external force applied to the electrode processing tool 200).

Thus, the upper electrode 2 is inserted through the guide hole 311 of the upper guide member 310, and the lower electrode 3 is inserted through the guide hole 321 of the lower guide member 320. Thus, the centerline of each of these electrodes 2 and 3 is made to coincide with the central position of each of the transfer processing units 210 and 220, each of the electrodes 2 and 3 can be kept from diagonally coming into contact with the electrode processing tool 200 at the time of transfer processing, and the recess portions 21 and the projection portion 22 are molded well over the entire electrode tip portion 20. Incidentally, in the case of the present modification example, it is also possible to omit the coil springs 130 (cancel elastic support). Incidentally, at the time of welding, the upper electrode 2 may be inserted through the guide hole 311 of the upper guide member 310.

### Second Modification Example

Next, a second modification example will be described. The present modification example is also different in the configuration of the processing device 100 for the electrode for welding from the foregoing embodiment. Only what is different from the foregoing embodiment will be described hereinafter as well.

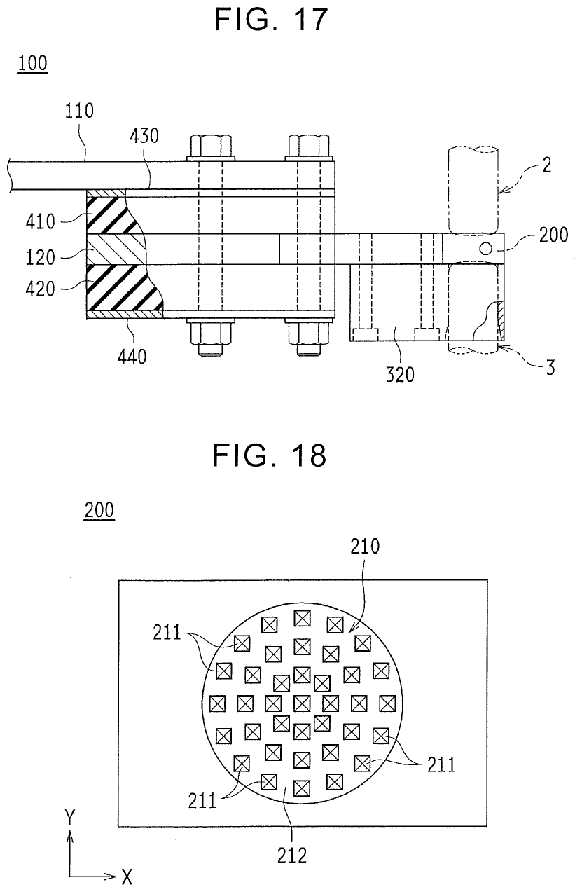

FIG. 16 is a plan view of the processing device 100 for the electrode for welding in the present modification example. Besides, FIG. 17 is a partially broken lateral view of the processing device 100 for the electrode for welding in the present modification example. As shown in these drawings, the processing device 100 for the electrode for welding in the present modification example employs urethane rubber pieces 410 and 420 instead of the plurality of the coil springs, as members for elastically supporting the electrode processing tool holder 120 on the device body 110.

In concrete terms, the urethane rubber pieces 410 and 420 are superimposed on both upper and lower sides of the electrode processing tool holder 120 of the processing device 100 for the electrode for welding respectively. An upper plate 430 is superimposed on an upper surface of the upper urethane rubber piece 410, and a lower plate 440 is superimposed on a lower surface of the lower urethane rubber piece 420. Furthermore, there is adopted a configuration in which the device body 110 is superimposed on an upper surface of the upper plate 430, and this electrode processing tool holder 120, these respective urethane rubber pieces 410 and 420, these respective plates 430 and 440, and this device body 110 are integrally bolted.

Incidentally, in the present modification example, a guide member 320 for guiding the lower electrode 3 is mounted on a lower surface of the electrode processing tool holder 120 through bolting.

According to the configuration of the present modification example, the electrode processing tool holder 120 is elastically supported by the device body 110 via the urethane rubber pieces 410 and 420. Therefore, as is the case with the foregoing embodiment, even when each of the electrodes 2 and 3 diagonally comes into contact with the electrode processing tool 200, namely, even when the direction in which each of the electrodes 2 and 3 moves is inclined with respect to the direction perpendicular to the direction in which each of the transfer processing units 210 and 220 extends at the time of transfer processing of each of the electrode tip portions 20 and 30, the posture of the electrode processing tool 200 changes due to elastic deformation of each of the urethane rubber pieces 410 and 420 upon contact of each of the electrodes 2 and 3 with the electrode processing tool 200, and each of the transfer processing units 210 and 220 can be made to extend in the direction perpendicular to the direction in which each of the electrodes 2 and 3 moves. Thus, the similar recess portions 21 are molded over an extensive range of the electrode tip portion 20, and the recess portions 21 and the projection portion 22 of the electrode tip portion 20 can be molded well.

### Third Modification Example

Next, a third modification example will be described. The present modification example is different from the foregoing embodiment in the manner in which the plurality of the protrusions 211 that are provided at each of the transfer processing units 210 and 220 of the electrode processing tool 200 are disposed (arranged). Accordingly, only the manner in which the protrusions 211 are disposed will be described hereinafter.

FIG. 18 is a view corresponding to FIG. 8 in the present modification example. As shown in this FIG. 18, in the electrode processing tool 200 according to the present modification example as well, the plurality of the protrusions 211, which are independent of one another, are disposed in a dispersed manner at the transfer processing unit 210.

Moreover, the transfer processing unit 210 of the electrode processing tool 200 according to the present modification example is configured such that the respective protrusions 211 are disposed along a plurality of virtual circular loci on concentric circles. Besides, the protrusions 211 are disposed such that the distance between those of the protrusions 211 which are adjacent to each other decreases as the locations thereof approach the central side.

The electrode processing tool 200 in the present modification example can also achieve an effect similar to that of the foregoing embodiment.

### Fourth Modification Example

Next, a fourth modification example will be described. The present modification example is also different from the foregoing embodiment in the manner in which the plurality of the protrusions 211 that are provided at each of the transfer processing units 210 and 220 of the electrode processing tool 200 are disposed. Accordingly, only the manner in which the protrusions 211 are disposed will be described hereinafter as well.

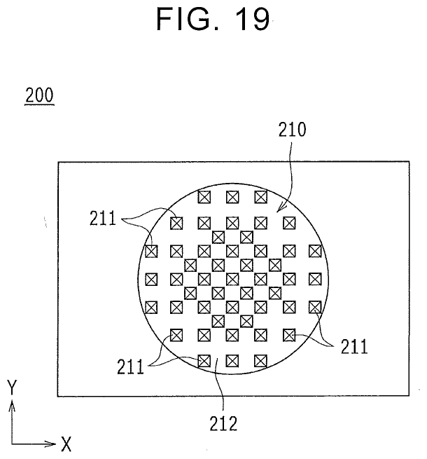

FIG. 19 is a view corresponding to FIG. 8 in the present modification example. As shown in this FIG. 19, in the electrode processing tool 200 according to the present modification example as well, the plurality of the protrusions 211, which are independent of one another, are disposed in a dispersed manner at the transfer processing unit 210.

Moreover, in the transfer processing unit 210 of the electrode processing tool 200 according to the present modification example, the respective protrusions 211 are arranged in the form of a lattice, and the arrangement of the protrusions 211 in a region of a central portion of the transfer processing unit 210 is made different from the arrangement of the protrusions 211 in a region on an outer peripheral side of the transfer processing unit 210. In concrete terms, in the state of arrangement of the respective protrusions 211 in the foregoing embodiment, there is adopted a configuration in which the single protrusion 211 is disposed between those of the protrusions 211 which are adjacent to each other only in the region of the central portion. That is, according to this configuration, the density of disposition of the protrusions 211 is set higher in the region of the central portion than in the region of the outer peripheral side.

The electrode processing tool 200 in the present modification example can also achieve an effect similar to that of the foregoing embodiment.

### Other Embodiments

Incidentally, the disclosure is not limited to the foregoing embodiment and the respective modification examples, but can be subjected to all the modifications and applications that are encompassed by the claims and those equivalent in scope thereto.

For example, in each of the foregoing embodiment and the respective modification examples, the case where the disclosure is applied as the electrode processing tool 200, the processing device 100 for the electrode for welding, and the processing method for the electrode for welding for processing the electrode tip portions 20 and 30 of the electrodes 2 and 3 that weld the two aluminum alloy plate materials W1 and W2 to each other has been described. The disclosure is not limited to this, but can also be applied with a view to processing the electrode tip portions 20 and 30 of the electrodes 2 and 3 for welding other metal plate materials to each other. For example, the disclosure can also be applied with a view to processing the electrode tip portions 20 and 30 of the electrodes 2 and 3 for welding ultra-high tensile strength steel plates (hot stamp materials), which are prepared by being subjected to special processing (press working or the like) while being heated, to each other. Besides, the disclosure can also be applied with a view to processing the electrode tip portions 20 and 30 of the electrodes 2 and 3 for welding three or more metal plate materials to one another.

Besides, in each of the foregoing embodiment and the respective modification examples, each of the electrode tip portions 20 and 30 is provided with the recess portions 21 and the projection portion 22 for the purpose of destroying the oxidation film. The disclosure is not limited to this, but may be applied to metal plate materials where there is no oxidation film, and each of the electrode tip portions 20 and 30 may be provided with the recess portions 21 and the projection portion 22 for the purpose of eliminating the influence of a mold releasing agent and an oil film present on the surface of each of the metal plate materials.

Besides, in each of the foregoing embodiment and the respective modification examples, each of the protrusions 211 assumes the shape of a quadrangular pyramid. The disclosure is not limited to this, but each of the protrusions 211 may assume the shape of a circular cone, a triangular pyramid or the like. Besides, the tips of the protrusions 211 are not necessarily required to be pointed, as long as the recess portions 21 can be molded at each of the electrode tip portions 20 and 30.

Besides, the arrangement of the plurality of the protrusions 211 is not limited to that of each of the foregoing embodiment and the respective modification examples. The plurality of the protrusions 211 may be dispersed randomly, for example, at positions that are non-symmetric with respect to the central position of each of the transfer processing units 210 and 220.

The disclosure can be applied to a processing tool for an electrode for welding that processes an electrode tip portion of an electrode for resistance spot welding for welding aluminum alloy plate materials to each other.

What is claimed is:

1. A processing tool for an electrode for resistance spot welding that is adapted to mold a projection portion and a plurality of recess portions, through transfer processing, at an electrode tip portion of the electrode for the resistance spot welding which bulges into a projecting shape, comprising:
a transfer processing unit that is configured to carry out the transfer processing of the projection portion and the plurality of the recess portions at the electrode tip portion, wherein
the transfer processing unit is provided with a plurality of protrusions that are configured to mold the plurality of the recess portions at the electrode tip portion, and
a virtual plane that links tips of the plurality of the protrusions with one another assumes a shape coinciding with a surface shape of the electrode tip portion bulging into the projecting shape before the transfer processing.

2. The processing tool for the electrode for the resistance spot welding according to claim 1, wherein
a bottom surface of the transfer processing unit, which is a region other than regions where the plurality of the protrusions are provided, also assumes the shape coinciding with the surface shape of the electrode tip portion bulging into the projecting shape before the transfer processing.

3. The processing tool for the electrode for the resistance spot welding according to claim 1, wherein
each of the protrusions assumes a shape of a cone that is tapered toward a tip side thereof.

4. The processing tool for the electrode for the resistance spot welding according to claim 3, wherein
the transfer processing is carried out through movement of the electrode for the resistance spot welding in a direction along a centerline of the electrode for the resistance spot welding and pressing of the electrode tip portion against the transfer processing unit, and
a centerline of each of the protrusions extends in the direction along the centerline of the electrode for the resistance spot welding when the transfer processing is carried out.

5. The processing tool for the electrode for the resistance spot welding according to claim 1, wherein
the plurality of the protrusions are disposed in a dispersed manner at positions that are point-symmetric with respect to a central position of the transfer processing unit, at the transfer processing unit.

6. The processing tool for the electrode for the resistance spot welding according to claim 1, wherein
a height of each of the protrusions is equal to or higher than 30 μm and equal to or lower than 150 μm.

7. The processing tool for the electrode for the resistance spot welding according to claim 1, wherein
a distance between central positions of those of the protrusions which are adjacent to each other is equal to or longer than 400 μm and equal to or shorter than 1200 μm.

8. The processing tool for the electrode for the resistance spot welding according to claim 1, wherein
a bottom surface of each of the protrusions is square, and
a length of one side of the bottom surface of each of the protrusions is equal to or longer than 80 μm and equal to or shorter than 350 μm.

9. A processing device for an electrode for resistance spot welding, comprising:
the processing tool for the electrode for the resistance spot welding according to claim 1.

10. The processing device for the electrode for the resistance spot welding according to claim 9, further comprising:
a device body, wherein
the processing tool for the electrode for the resistance spot welding is retained by the device body via an elastic body.

11. The processing device for the electrode for the resistance spot welding according to claim 9, further comprising:
a shaping device that is configured to perform a shaping operation for bulging the electrode tip portion of the electrode for the resistance spot welding into a predetermined projecting shape, at a stage prior to the transfer processing of the projection portion and the plurality of the recess portions by the processing tool for the electrode for the resistance spot welding, wherein
a shape of a shaping unit of the shaping device on which the electrode tip portion abuts coincides with a shape of the virtual plane that links the tips of the plurality of the projections of the processing tool for the electrode for the resistance spot welding with one another.

12. A processing method for an electrode for resistance spot welding in which a projection portion and a plurality of recess portions are molded at an electrode tip portion of the electrode for the resistance spot welding bulging into a projecting shape according to transfer processing through use of a processing tool for the electrode for the resistance spot welding, wherein
the processing tool for the electrode for the resistance spot welding is equipped with a transfer processing unit that is configured to transfer the projection portion and the plurality of the recess portions at the electrode tip portion,
the transfer processing unit is provided with a plurality of protrusions that are configured to mold the plurality of the recess portions, and
a virtual plane that links tips of the plurality of the protrusions with one another assumes a shape coinciding with a surface shape of the electrode tip portion bulging into the projecting shape before the transfer processing,
the processing method for the electrode for the resistance spot welding comprising:
carrying out the transfer processing of the projection portion and the plurality of the recess portions at the electrode tip portion by pressing the electrode tip portion against the transfer processing unit of the processing tool for the electrode for the resistance spot welding.
